(19) United States
(12) Patent Application Publication
(10) Pub. No.: US 2008/0128039 A1
(43) Pub. Date: Jun. 5, 2008

(54) Hand tool for plugging conduit

(76) Inventors: Daniel W. Cox, Vernon Hills, IL (US); Kevin M. Schnurstein, McHenry, IL (US)

Correspondence Address: Charles F. Meroni, Jr., P.O. Box 309, Barrington, IL, 60011, US

(21) Appl. No.: 11/634,473

(22) Filed: Dec. 5, 2006

(51) Int. Cl. F16L 55/12; B65D 69/00

(52) U.S. Cl. 138/89; 206/223

(57) ABSTRACT

A conduit-plugging hand tool comprises a conduit-insertable shaft assembly and a toggle-lockable pincer assembly. The shaft assembly comprises coaxial inner and outer shafts, and a bulb member. The bulb member is spatially situated intermediate the distal ends of the inner and outer shafts such that when the shafts are coaxially displaced relative to one another, the bulb member may be axially compressed and radially expanded for selectively blocking conduit. The pincer assembly comprises first and second jaws, and a toggle-locking mechanism. The first jaw is coupled to the proximal inner shaft end, and the second jaw is coupled to a proximal outer shaft end. The toggle-mechanism operates to displace the first jaw along a shaft axis relative to the second jaw. The inner and outer shaft members are thereby coaxially displaceable relative to one another for longitudinally compressing the bulb member and effecting radial bulb member expansion.

### BACKGROUND OF THE INVENTION

1. Field of the Invention

The present invention generally relates to a hand tool for plugging conduit. More particularly, the present invention relates to conduit-plugging hand tool with a toggle-locking hand-grippable portion that enables user's thereof to conduct further conduit maintenance with the use of two hands after having toggle-locked the hand tool in a conduit-plugging position.

2. Description of the Prior Art

Individualized toggle-locking pliers assemblies and conduit-plugging plumber's tools are well known in the arts. The combination of a toggle-locking pliers assembly and a conduit-plugging shaft assembly, however, is absent from the prior art. For example, certain prior art related to individualized toggle-locking pliers assemblies and the like is briefly described in U.S. Pat. No. 5,056,385 ('385 Patent), which issued to Petersen, and discloses a Compound Toggle Link. The '385 Patent teaches a quick release for a conventional pliers-type, toggle-locking hand tool comprising a compound toggle link. The link is pivotably mounted between the movable handle and the conventional toggle member. Four pivot points rather than the usual three form the “power line” of the tool. Locking the tool involves pushing the two internal pivot points inwardly across the power line. Release involves opening the handles which moves the internal pivot points back across the power line.

Further, U.S. Pat. No. 6,626,070 ('070 Patent), which issued to Peperkorn et al., discloses a Compound Toggle Link Retention Mechanism. The '070 Patent teaches a quick release and toggle locking mechanism for a conventional pliers-type, toggle-locking hand tool. The mechanism includes a compound link pivotally connected to a movable handle and a toggle link. Retention means is provided for restricting pivotal movement of the compound link relative to the movable handle.

Certain prior art related to conduit-plugging hand tools and the like includes U.S. Pat. No. 3,704,729 ('729 Patent), which issued to Tomlinson. The '729 Patent discloses a plumbing device for plugging a pipe includes a radially expansible rubber sleeve disposed about one end of an axial shaft or tube. An annular flange is provided on the end of the shaft while an elongated metal cylinder is disposed coaxially about the shaft on the opposite side of the sleeve to transmit axial compressive movement to the rubber sleeve from a screw jack mechanism releasably secured on the shaft in proximity to its other end.

U.S. Pat. No. 4,529,007 ('007 Patent), which issued to Goforth, discloses a Quick Stop Soldering Plug and Method for Using Same. The '007 Patent teaches a quick stop soldering valve used for closing off an elongated pipe having an open end and an interior cylindrical pipe wall. The valve includes an elongated rod having a compressible plug mounted on one end thereof. A sleeve fits over the other end of the rod and engages the compressible plug. By pulling the rod longitudinally through the sleeve it is possible to compress the plug axially and as a result cause the plug to expand radially outwardly. When the plug is inserted within the pipe, and is expanded radially outwardly, it forms a sealing engagement with the interior surface of the pipe wall.

U.S. Pat. No. 5,224,516 ('516 Patent), which issued to McGovern et al., discloses a Pipe Repair Tool. The '516 Patent teaches tool for use in the repair of fluid conduits or pipes that functions to prevent fluid flow along the interior surface of the pipe, while allowing flow through a central bypass tube. The tube also serves to support an expandable plug which is axially compressed by a concentric compression tube surrounding the bypass tube. As the compression tube axially compresses the plug, the plug is forced to expand radially due to the flexible nature of the center section wall and the air entrapped therein. As no great amount of pressure is trapped behind the plug due to the communication of the pipe with the outside environment through the bypass tube, relatively low forces may be used in the actuation of the tool. Moreover, the thin wall or membrane of the center section of the plug permits a relatively wide range of expansion, allowing a single plug to be used in a wide variety of pipe sizes. The tool is particularly suited to use with copper water pipes, but is adaptable to virtually any type of fluid conduit or pipe.

U.S. Pat. No. 5,819,804 ('804 Patent), which issued to Ferrer et al., discloses a Hand Tool for Temporary Plugging of Pipe Conduits. The '804 Patent teaches an instrument for temporarily sealing a pipe against fluid flow comprising a manually actuatable handle and a sealing unit engaged to the handle, the sealing unit having a seal assembly supported at one end of a flexible cable operatively connected to the handle. The sealing assembly comprising an elastomeric seal contained between first and second compression elements which compress the elastomeric seal into an expanded state upon actuation of the handle.

From an inspection of the foregoing disclosures as well as from a consideration of the art in general, it will be seen that the prior art does not teach or otherwise disclose a conduit-plugging hand tool comprising a conduit-insertable expansive-bulb assembly in combination with a toggle-locking pliers assembly. The prior art thus perceives a need for such a device insofar as the combination device provides distinct advantages over prior or current conduit-plugging hand tools, as set forth in more detail hereinafter.

### SUMMARY OF THE INVENTION

Accordingly, the prior art perceives a need for a combination hand tool comprising a conduit-plugging bulb mechanism and a toggle-locking pincer assembly, which together may well function to aid conduit workers to plug conduit with an easy to use hand tool, lock the tool in a conduit-plugged state, and attend to the conduit job at hand with the use of both hands. To achieve these and other readily ascertainable objectives, the present invention provides a conduit-plugging hand tool comprising a conduit-insertable shaft assembly and a toggle-lockable pincer assembly.

The shaft assembly comprises inner and outer telescoped shaft members, and a bulb member. The outer shaft member has proximal and distal outer shaft ends, the inner shaft has proximal and distal inner shaft ends, and the bulb member has proximal and distal bulb ends. The bulb member is spatially situated intermediate the distal ends of the inner and outer shaft member, such that when the outer and inner shaft members are coaxially displaced relative to one another, the bulb member may be axially compressed thereby effecting radial expansion of the bulb member for selectively blocking conduit.

The toggle-locking pincer assembly comprises first and second jaws, and certain jaw-displacing means for displacing the first and second jaws relative to one another. The first and second jaws extend into a pincer-receiving channel structure, which structure is coupled to or integrally formed with the outer shaft member. The first jaw is coupled to the proximal inner shaft end, and the second jaw is pivotally coupled to the pincer-receiving channel. The jaw-displacing means operate to displace the first jaw along the shaft axis relative to the second jaw. The inner and outer shaft members are thereby coaxially displaceable relative to one another for longitudinally compressing the bulb member and effecting radial bulb member expansion. The bulb member is thus actuable intermediate a relaxed bulb state and an actuated bulb state. The relaxed bulb state enables shaft assembly insertion in a target conduit, and the actuated bulb state functions to selectively plug the target conduit.

### BRIEF DESCRIPTION OF THE DRAWINGS

Other features of our invention will become more evident from a consideration of the following brief description of patent drawings:

FIG. 1 is a first side plan view of a first preferred embodiment of the hand tool of the present invention showing a shaft assembly and a toggle-locking pincer assembly in a relaxed state.

FIG. 2 is an enlarged fragmentary side view depiction of the shaft assembly as coupled to the pincer assembly in a relaxed state.

FIG. 3 is a first side plan view of a first preferred embodiment of the hand tool of the present invention showing the shaft assembly and the toggle-locking pincer assembly in an actuated state.

FIG. 4 is an enlarged fragmentary side view depiction of the shaft assembly as coupled to the pincer assembly in an actuated state.

FIG. 5 is a second side depiction of a first preferred embodiment of the hand tool of the present invention showing the shaft assembly and the toggle-locking pincer assembly as inserted in certain conduit in an actuated, conduit-plugging state.

FIG. 6 is a first side depiction of a first preferred embodiment of the hand tool of the present invention in an exploded or disassembled state.

FIG. 7 is a top perspective view of a hand tool kit contemplated by the present invention showing a plurality of shaft assemblies and a single pincer assembly and provided in carrying case or package.

FIG. 8 is a first side plan view of a preferred pincer assembly of the present invention in a relaxed state.

FIG. 8(a) is an enlarged side view depiction of a portion of the pincer assembly shown in FIG. 8 with certain parts broken away to show otherwise hidden structure.

FIG. 9 is a fragmentary bottom perspective view of the junction intermediate the shaft assembly and the pincer assembly of the present invention depicting first and second jaws being received in a jaw-receiving channel structure.

FIG. 10 is a fragmentary bottom perspective view of the junction intermediate the shaft assembly and the pincer assembly of the present invention with the first and second jaws removed from the jaw-receiving channel structure.

FIG. 11 is a fragmentary bottom plan view of the shaft assembly and jaw-receiving channel structure of the present invention.

FIG. 12 is an end view depiction of the bulb member of the present invention depicting a relaxed bulb state as shown in solid lines and an actuated bulb state as shown in broken lines.

FIG. 13 is an end view depiction of a plurality of variously dimensioned bulb members, each in a relaxed state and comparatively depicting a plurality of bulb member diameters.

FIG. 14 is a first side plan view of a second preferred embodiment of the hand tool of the present invention showing sleeve-enclosed shaft assembly and a toggle-locking pincer assembly in a relaxed state.

FIG. 15 is an enlarged fragmentary side view depiction of a portion of the junction intermediate the pincer assembly and shaft assembly of the present invention showing a press pin connection.

### DETAILED DESCRIPTION OF THE PREFERRED EMBODIMENT(S)

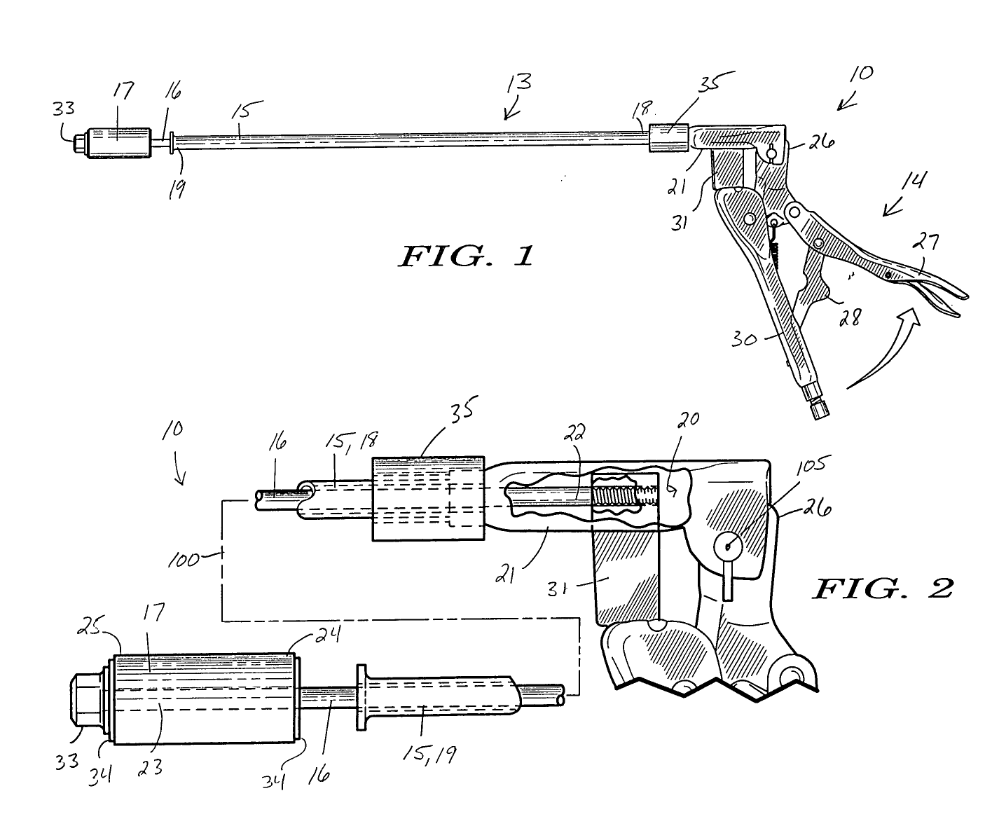

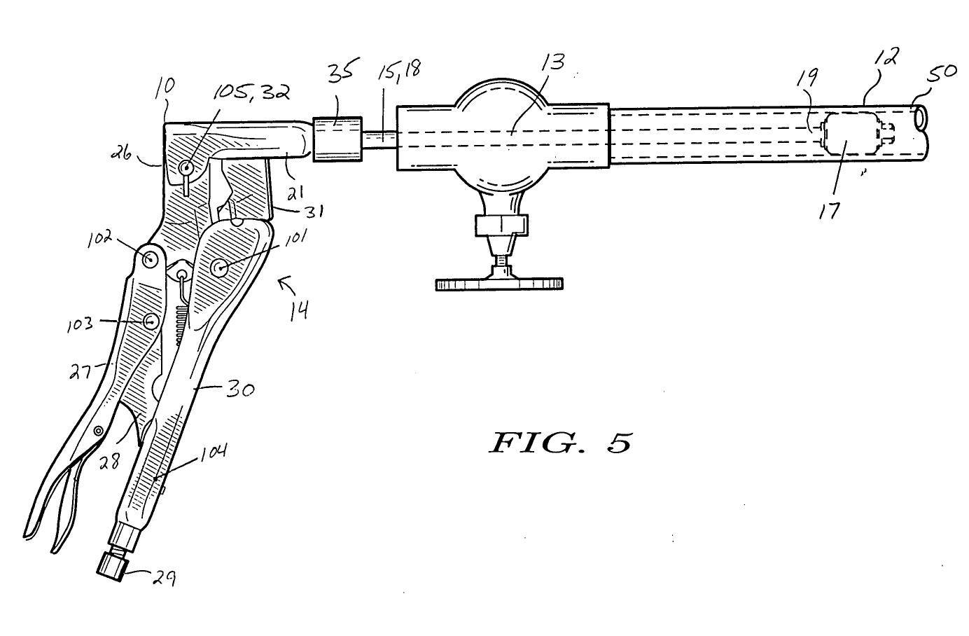

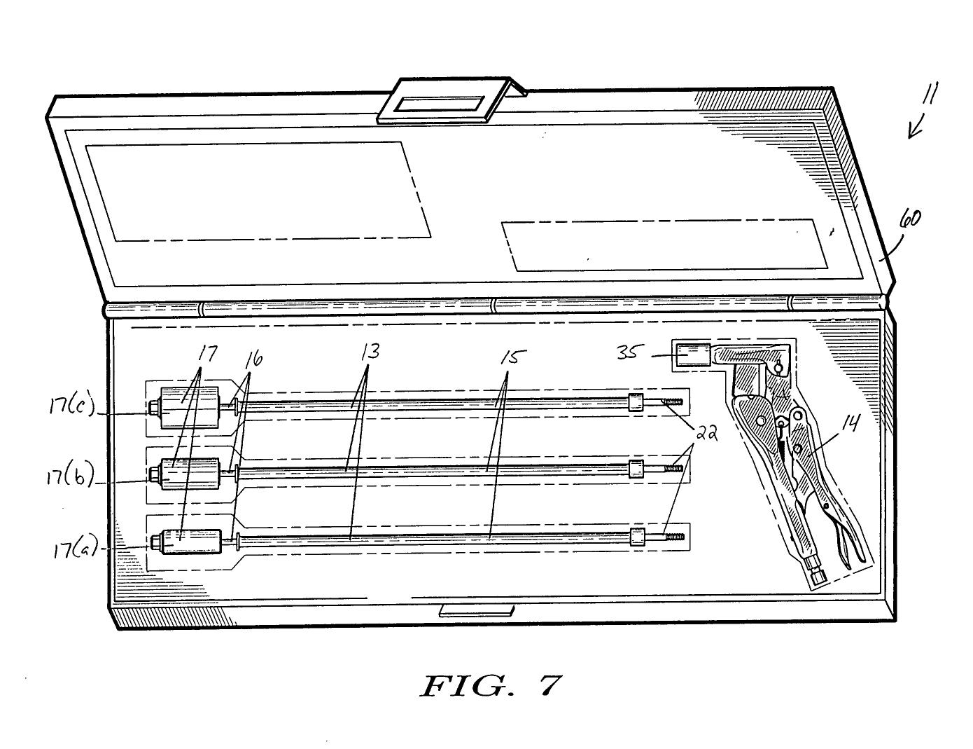

Referring now to the drawings with more specificity, the preferred embodiment of the present invention generally concerns a plumbing type hand tool or plumber's hand tool 10 as generally illustrated and referenced in FIGS. 1-6, and 14. Further, from an inspection of FIG. 7, it may be seen that the teachings of the present invention also contemplate a hand tool kit 11 comprising various components conveniently provided to users in a package 60, which components may be selectively assembled to form hand tool 10. It is contemplated that both the hand tool 10 and the hand tool kit 11 of the present invention may effectively function to plug plumbing type conduit 12 as generally depicted in FIG. 5. The hand tool 10 of the present invention may be said to preferably achieve the foregoing and other readily apparent objectives by comprising a conduit-penetrable shaft assembly 13 as illustrated and referenced in FIGS. 1, 3, 5-7, and 14; and a bulb-actuating pliers assembly or pincer assembly 14 as illustrated and referenced in FIGS. 1, 3, 5-8, and 14.

The shaft assembly 13 of the present invention may be said to preferably comprise a hollow, substantially rigid outer shaft member 15 as illustrated and referenced in FIGS. 1-7, and 9-11; a substantially rigid inner shaft member 16 as illustrated and referenced in FIGS. 1, 2, 4, 6, 7, 9-11, and 14; and a compressible, radially expandable, conduit-blockable bulb member 17 as illustrated and referenced in FIGS. 1-7, and 14. It should be readily understood from a consideration of the FIGS. 1-6 that the outer shaft member 15 comprises a proximal outer shaft end 18 and a distal outer shaft end 19. Further, from an inspection of FIGS. 2, 4, and 9-11, it will be seen that the proximal outer shaft end 18 preferably comprises, is attached to, or terminates in a jaw-receiving channel or slot 20.

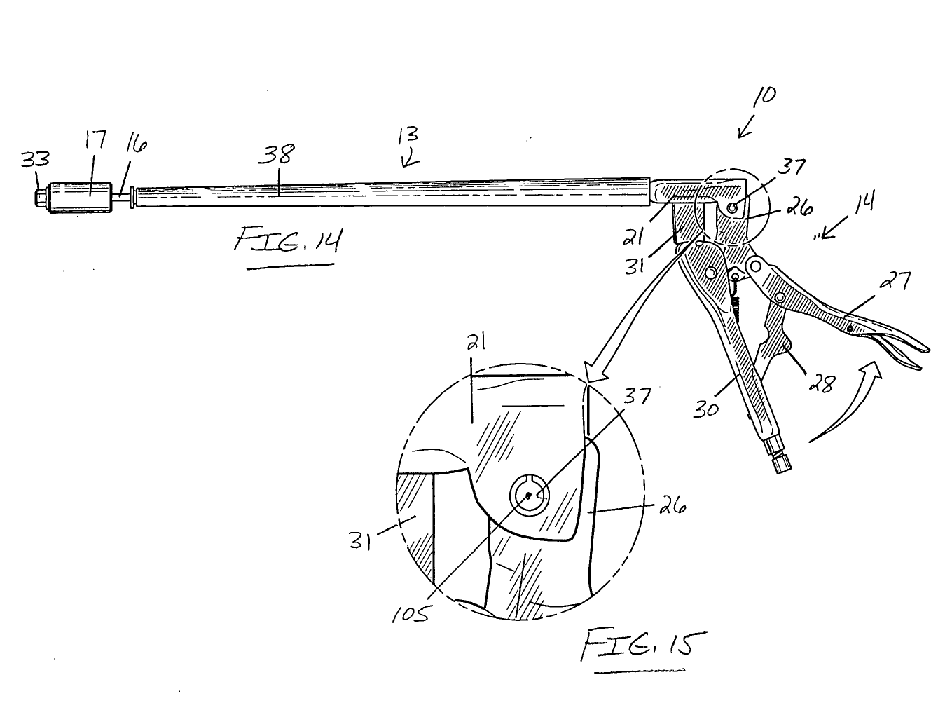

In this last regard, it will be seen from an inspection of the figures that the jaw-receiving channel 20 of the present invention is depicted as separately fitted to outer shaft member 15 via a coupling collar 35 as illustrated and referenced in FIGS. 1-7, and 9-11. Alternatively, it is contemplated that a transparent coupling sleeve 38 may envelope the outer shaft member 15 and distal portion of the jaw-receiving channel 20 as generally depicted in FIG. 14. The foregoing structure(s) may embody the preferred method(s) for constructing the hand tool 10 of the present invention for certain manufacturers. However, it is further contemplated that an outer shaft member structurally configured to define a jaw-receiving channel 20 at its proximal end would also be structurally successful to fulfill the objectives of the present invention. In other words, it is contemplated that a flared, slotted proximal end of an outer shaft member may well function to define a jaw-receiving channel as may be required by the present invention. Notably, the structural purpose of the jaw-receiving channel 20 is to guide certain jaw structure of the pincer assembly 14. For descriptive purposes here, however, the jaw-receiving channel 20 preferably comprises or is bounded by laterally opposed jaw-guiding walls or flanges 21 as further illustrated and referenced in FIGS. 1-6, 8-11, 14, and 15.

It will be further noted that the inner shaft member 16 also has a proximal inner shaft end 22 as referenced in FIGS. 2, 4, 6, 7, and 9-11, and a distal inner shaft end 23 as referenced in FIGS. 2, 4, and 6; and the bulb member 17 has a proximal bulb end 24 and a distal bulb end 25 as referenced in FIGS. 2, 4, and 6. It should be further understood from a comparative inspection of FIGS. 1-4, 6, 7, 9-11 that the outer shaft member 15 receives or surrounds the inner shaft member 16 such that the outer and inner shaft members 15 and 16 are coaxial about a shaft axis 100 as referenced in FIGS. 2, 4, 6, and 11. Notably, from an inspection of FIGS. 2, 4, and 9-11, it will be seen that the proximal inner shaft end 22 preferably extends into the jaw-receiving channel 20.

Turning now to the pincer or pliers assembly, it will be noted from a consideration of the prior art, that toggle-locking pliers assemblies typically utilize a movable jaw and a fixed jaw to firmly grasp and lock onto a work piece. Typically, the movable jaw may be adjusted to grasp the work piece as the handles are compressed together. As the handles are more tightly compressed, the toggle mechanism will lock the hand tool onto the work piece. After the user releases the handles, the tool will remain firmly locked in place. Adjustments to the clamping force may generally be made by rotating an adjusting screw in the base of the fixed handle. By rotating the screw, the configuration of the toggle mechanism of the pliers assembly is modified, thereby providing more or less relative force between the handle position and the position of the closed or open jaws.

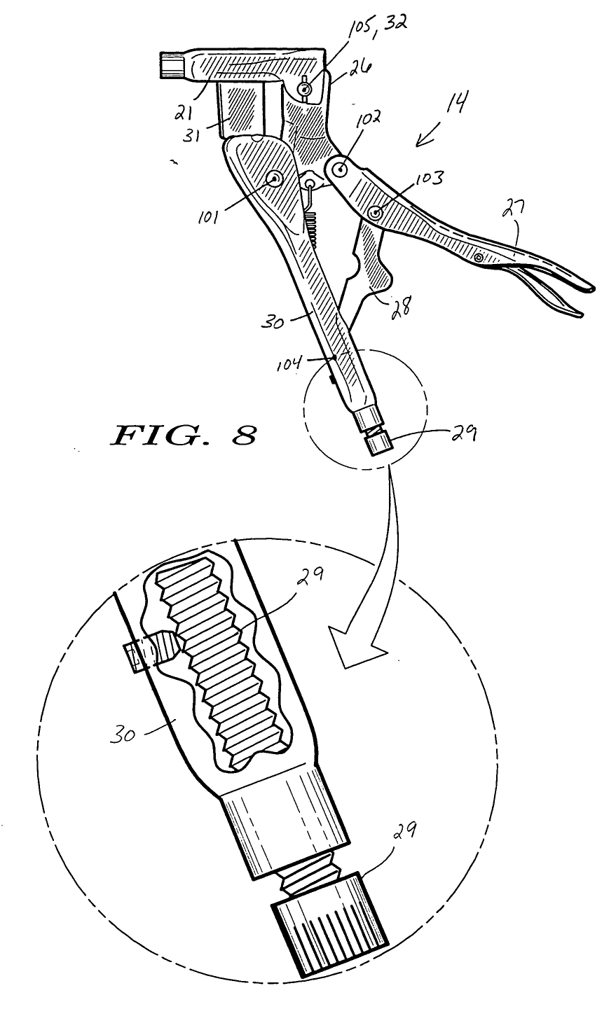

The bulb-actuating pliers assembly or pincer assembly 14 of the present invention is essentially a modified toggle-locking pliers assembly having all pivot points of conventional traditional toggle-locking pliers, but further comprising modified jaw structures for attachment to the shaft assembly 13. In a conventional toggle-locking pliers assembly, there are four pivot points 101, 102, 103, and 104 around which the parts of the assemblage rotate in order to open and close the assembly. Four such pivot points are referenced in FIGS. 5 and 8. In the open position, as may be generally seen in FIG. 8, these four pivots outline a trapezoidal type configuration. In the closed position, as generally depicted in FIG. 5, pivot points 101, 102, and 104 approximate a right triangle. The hypotenuse of this triangle, containing three of the pivot points 102, 103, and 104, is often referred to as the so-called “power line”. The right angle of the right triangle is the pivot point 102 for the movable jaw in convention toggle-locking pliers. Further, the hypotenuse contains the pivot point 102 for the movable handle at the movable jaw and the pivot point 103 for the toggle link on the movable handle. One end of the toggle link is also on the hypotenuse, the same having a pivoting, and sliding contact at the end or tip of the adjusting screw in the channel of the fixed handle of the tool as at 104 in the noted figures. Locking a conventional pliers assembly moves the toggle link pivot point 103 with the moving handle inwardly slightly across the power line forming the right triangle. Releasing the conventional pliers assembly snaps the toggle link pivot point 103 with the moving handle outwardly away from the fixed handle, beyond the former power line.

In the pliers assembly 14 of the present invention, in contradistinction to conventional toggle-locking pliers assemblies, the right angle of the right triangle is the pivot point 102 for a (pivotable) jaw 26 as illustrated and referenced in FIGS. 1-6, 8, 9, 14, and 15. Jaw 26 of the present invention, notably, is further pivotable about a fifth pivot point 105 as referenced in FIGS. 2, 4, 5, 6, 8, 11, and 15. The hypotenuse contains the pivot point 102 for a handle 27 at the pivotable jaw 26 and the pivot point 103 for the toggle link 28 on the handle 27 as depicted and referenced in FIGS. 5 and 8. On the hypotenuse is the other end of the toggle link 28 in a pivoting (as at 104), sliding contact at the upper end or tip of the adjusting screw 29 in the channel of handle 30 of the pliers assembly 14.

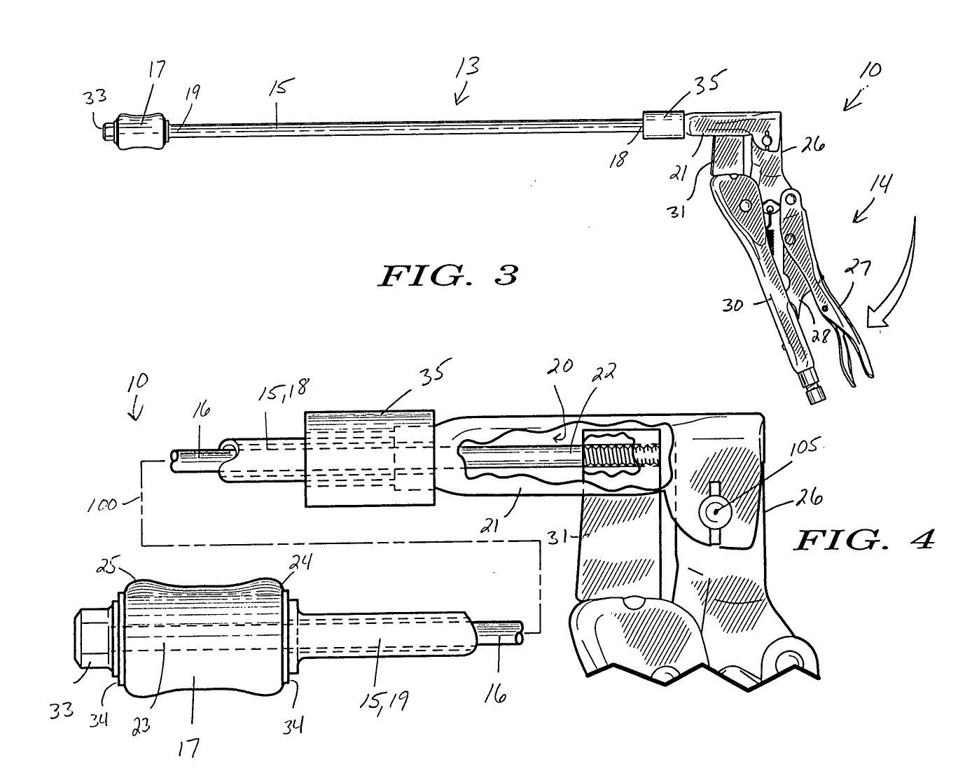

When locking the pliers assembly 14 of the present invention, one may move the toggle link pivot point 103 into the power line position as in the convention case. In so doing, both handles 27 and 30 are displaced toward one another as comparatively shown in FIGS. 1 versus 3. The otherwise translatably moveable jaw of a conventional pliers assembly, however, becomes a pivotable jaw 26 in the present invention and thus functions to primarily draw or displace jaw 31 along shaft axis 100 toward jaw 26 as handles 27 and 30 are brought together (as depicted in FIG. 3), and pivot point 103 moves into the power line forming the right triangle. This position selectively prevents jaw-displacement or functions to temporarily lock the pliers assembly 14 in a closed state. Releasing pliers assembly 14 snaps the toggle link pivot point 103 with handle 27 outwardly away from handle 30 (as depicted in FIG. 1), beyond the former power line, thereby displacing jaw 31 along axis 101 away from jaw 26.

The pliers assembly 14 of the present invention may thus be said to preferably comprise a translatable, inner shaft-engaging jaw 31, a pivotable, outer shaft-engaging jaw 26, and certain jaw-displacing means. It is contemplated that the jaw-displacing means of the present invention may be preferably defined by a conventional or state of the art toggle mechanism such as the generic toggle mechanism specified herein or such as may be otherwise gleaned from exemplary U.S. Pat. Nos. 5,056,385 or 6,626,070, the specifications of which may be incorporated herein by reference thereto. The jaw-displacing means, in any event, essentially function to displace the inner and outer shaft-engaging jaws 31 and 26 relative to one another for imparting force(s) to the outer shaft member 15 and inner shaft member 16.

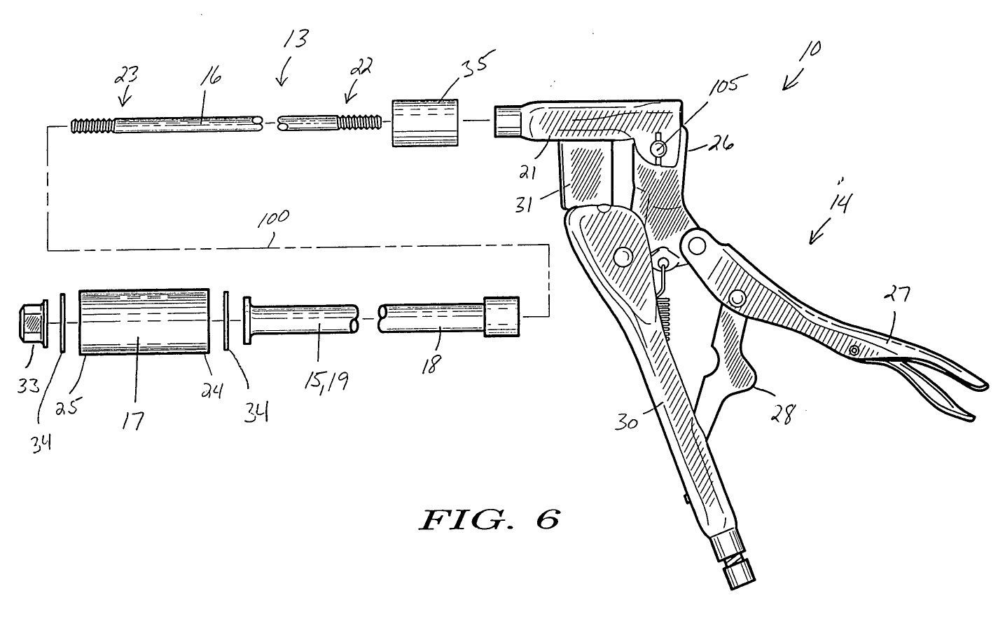

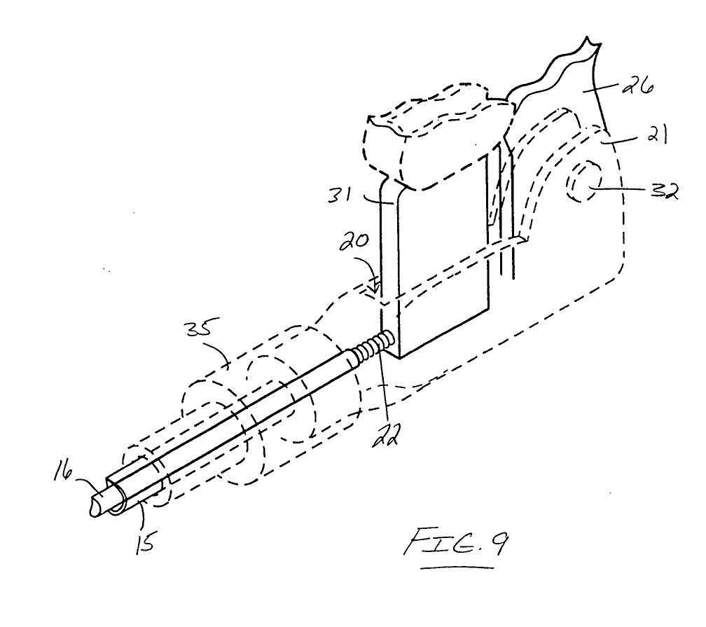

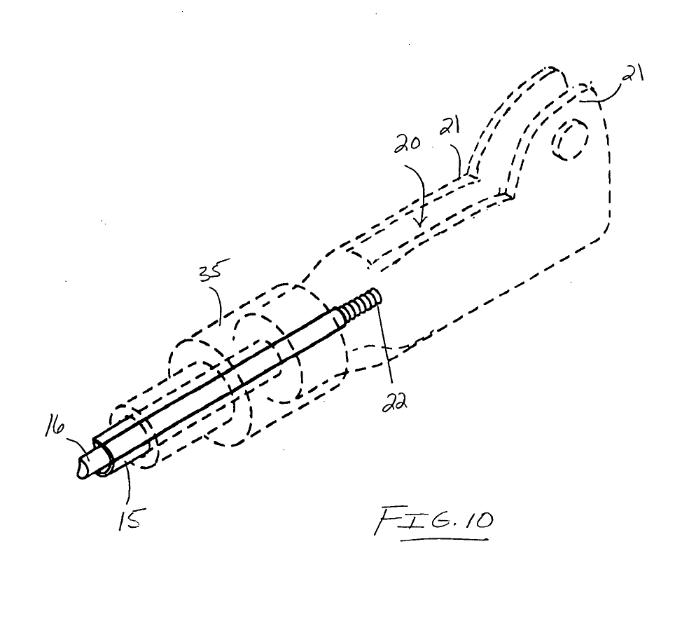

Notably, jaw 31 preferably receives or is otherwise coupled to proximal inner shaft end 22. From an inspection of FIG. 9, it will be seen that jaw 31 is coupled to proximal inner shaft end 22 as received in the jaw-receiving channel 20. However from a further inspection of FIGS. 10 and 11, it will be seen that jaw 31 is removed from the jaw-receiving channel 20 in order to (1) more clearly depict the channel 20, and (2) more clearly depict that the proximal inner shaft end is removably receivable by the jaw 31. In this regard, it should be noted that the inner shaft member 16 may be interchanged with other inner shaft members bearing bulb members of varying dimensions (as generally shown in FIG. 7). Thus contemplated that jaw 31 may preferably receive proximal inner shaft end 22 such that the same is removable. One means for achieving the removable receipt of proximal inner shaft end 22 is to threadably mate proximal inner shaft end 22 with jaw 31 as generally depicted in FIGS. 2, 4, and 9, and which threaded proximal inner shaft end 22 is further illustrated and referenced in FIGS. 6 and 7. Jaw 26, on the other hand is pivotably attached to the jaw-guiding flanges 21 via a pivot pin assembly such as a cotter pin assembly 32 or rivet pin assembly as referenced in FIGS. 5, 8, and 9 or alternatively a press pin assembly 37 or similar other pivot-enabling fastening means as referenced in FIGS. 14 and 15.

The inner and outer shaft-engaging jaws 31 and 26 may thus be said to preferably extend into the jaw-receiving channel 20 intermediate the jaw-guiding flanges 21, with the inner shaft-engaging jaw 31 being removably, but fixedly (e.g. threadably) coupled to the proximal inner shaft end 22, and the outer shaft-engaging jaw 26 being pivotally coupled to the jaw-guiding flanges 21 about a first pivot axis as referenced at 105. Notably, the first pivot axis 105 is preferably orthogonal relative to the shaft axis 100. It should be further noted that the toggle mechanism of the handle structures of the pliers assembly 14 notably comprises certain hand-grippable structure as may be defined by handles 27 and 30. When in a closed, bulb-compressing state, the hand-grippable structure comprises a significant dimension substantially orthogonal to the shaft axis 100 and pivot axis 105 for effecting an L-shaped or hand-gun shaped plumbing hand tool 10. It is contemplated that L-shaped implements such as hand guns or similarly shaped tools may well function to enhance a user's ability to selectively aim the tool. In this case, it is contemplated that the substantially L-shaped configuration of the hand tool 10 may well function to enhance a user's ability to selectively plug conduit, as for example, by enabling the user to aim or guide the shaft assembly 13 into conduit 12.

The jaw-displacing means may well function to simultaneously pivot the outer shaft-engaging jaw 26 about the first pivot axis 105 and displace the inner shaft-engaging jaw 31 along the shaft axis 100. The inner and outer shaft members 16 and 15 are thereby coaxially displaceable relative to one another for compressing the bulb member 17 via the distal inner and outer shaft ends 23 and 19. In this regard, it will be seen that distal inner shaft end 23 is also preferably threaded for receiving a terminal nut head 33 as illustrated and referenced in FIGS. 1-4, 6, and 14.

Further, it is contemplated that the shaft assembly 13 may comprise certain bulb-interfacing means for interfacing intermediate bulb member 17 and the distal inner and outer shaft ends 23 and 19 for enhancing uniform compressibility of the bulb member 17 via the distal inner and outer shaft ends 23 and 19. It is contemplated, for example, that the bulb-interfacing means may be preferably defined by first and second washers 34 as illustrated and referenced in FIGS. 2, 4, and 6. It will be understood that each of the first and second washers 34 comprise an inner washer diameter and an outer washer diameter, the inner washer diameter being greater in magnitude than the outer shaft diameter of inner shaft member 16, and the outer washer diameter being lesser in magnitude than a the relaxed bulb diameter of bulb member 17. It is contemplated that the distal inner and outer shaft ends 23 and 19 are thus cooperatively associated with the first and second washers 34 for uniformly compressing (and selectively expanding) the bulb member 17 via the proximal and distal bulb ends 24 and 25 as described in more detail hereinafter.

As heretofore specified, the inner shaft member 16 comprises a certain transverse outer shaft diameter. The bulb member 17, being preferably formed in the shape of a cylinder, has an inner bulb diameter. The inner bulb diameter is greater in greater in magnitude than the outer shaft diameter of the inner shaft member 16, such that the inner shaft member 16 may extend through the bulb member 17 via the inner bulb diameter for effecting certain distal bulb end stop structure as may be defined by terminal nut head 33.

The bulb member 17 of the present invention is preferably formed from an elastic or elastomeric type material. In this regard, the bulb member may be actuably compressed along its longitudinal axis to effect a radial expansion of the matter intermediate the proximal and distal bulb ends 25 and 24. Restorative forces inherent in the member 17 oppose the forces imparted thereon by the distal inner and outer shaft ends 23 and 19, but are overcome thereby. When the jaw-displacing means allow the jaws 31 and 26 to displace away from one another, the restorative force(s) inherent in the member 17 operate to return the bulb member 17 to a relaxed equilibrium state as generally depicted in FIGS. 1, 2, 6, 7, and 14.

When compressed, however, the bulb member 17 may be defined as compression-expandable. In other words, the material expands radially under compressive forces in the axial direction resulting in a larger bulb diameter. It is this larger bulb diameter that operates to selectively plug conduit 12 as generally depicted in FIG. 5. The bulb member 17 of the present invention is thus actuable intermediate an actuated bulb state as generally illustrated and depicted in FIGS. 3-5, and as specifically referenced at 36 in FIG. 12; and a relaxed bulb state as generally illustrated in FIGS. 1, 2, 6, 7, and 14, and as specifically referenced in FIG. 12. The bulb member 17 may thus be said to comprise a first bulb diameter when in the relaxed bulb state and a second bulb diameter when in the actuated bulb state. Notably, the first bulb diameter is lesser in magnitude than a target conduit diameter, thereby enabling insertion of the shaft assembly 13 in a target conduit such as conduit 12. The second bulb diameter, however, is substantially equal in magnitude to the target conduit diameter for selectively plugging the target conduit. Thus, the plumbing hand tool of the present invention may well function to selectively plug conduit 12 so that conduit maintenance may be more easily performed. In other words, the toggle-locked conduit-plugging hand tool enables user's thereof to utilize both hands to further attend to conduit maintenance and/or repair. Notably, adjustments to effect smaller or greater jaw-displacement(s) and bulb member compression force(s) may be made by rotating adjusting screw 29 in the base of the handle 30. By rotating the screw 29, the configuration of the toggle mechanism of the pliers is modified, thereby providing more or less relative force between the handle position and the position of the decreased jaw displacement (closed position) or increased jaw displacement (open position).

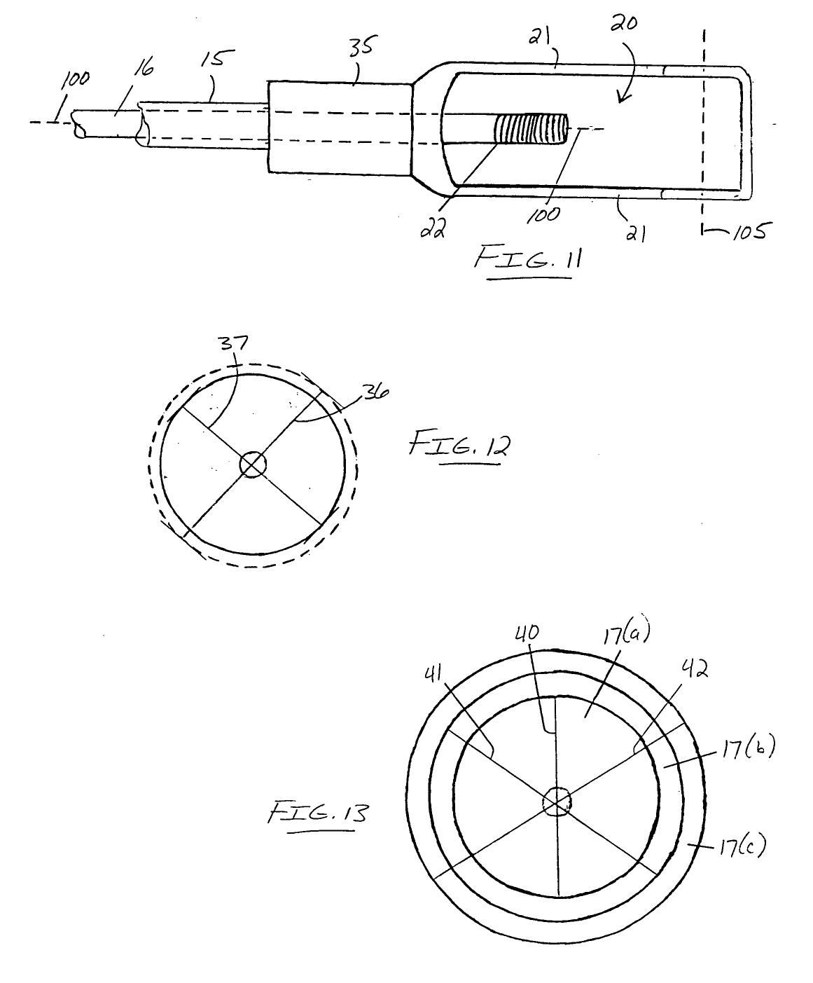

In terms of the hand tool kit 11 of the present invention as generally depicted in FIG. 11, it is contemplated that the hand took kit 11 may well function to enable user to plug variously dimensioned conduit or conduit having various diameters. In this regard, it is contemplated that the hand tool kit 11 may preferably comprise one or more outer shaft members 15, one or more inner shaft members 16, but essentially a plurality of uniquely sized and shaped bulb members 17, such as bulb members 17(a), 17(b), and 17(c) referenced in FIGS. 7 and 13, each of which have a different transverse diameter as generally depicted in FIG. 13 at reference numerals 40, 41, and 42, respectively. Conceivably, a plurality of inner shaft members 16 could be outfitted with a plurality of variously dimensioned bulb members 17 such that the resulting interchangeable inner shaft assemblies could provide the user with a selection of tools from which to choose for any given application. Further, as depicted in FIG. 7, a plurality of outer shaft members 15 may be outfitted with the heretofore specified inner shaft assemblies for ease of tool or shaft interchangeability. The variously dimensioned bulb diameters, however, are central to the kit and enable a user to choose or effect a select inner shaft assembly for plugging variously dimensioned conduit.

Further included in the kit is at least one pincer assembly 14, the pincer assembly comprising first and second jaws, such as jaw 31 and jaw 26, as well as certain jaw-displacing means as heretofore specified. The pincer assembly is cooperable with the select inner shaft assembly and outer shaft member for coaxially displacing the select inner shaft member relative to the outer shaft member for longitudinally compressing and radially expanding the select bulb member. The select bulb member thereby is actuable intermediate a relaxed bulb state and an actuated bulb state, the relaxed bulb state enabling inner shaft assembly insertion in a target conduit, and the actuated bulb state for selectively plugging the target conduit.

While the above descriptions contain much specificity, this specificity should not be construed as limitations on the scope of the invention, but rather as an exemplification of the invention. For example, the invention may be said to essentially teach or disclose an A conduit-plugging hand tool comprising a shaft assembly and a pincer assembly. The shaft assembly may be said to essentially comprise an inner shaft, an outer shaft, and a bulb member. The outer shaft member extends to a proximal outer shaft end, which proximal outer shaft end comprises a pincer-receiving channel. The inner and outer shafts are substantially coaxial about a shaft axis.

The pincer assembly may be said to essentially comprise first and second jaws, and certain jaw-displacing means. The jaw-displacing means operate to displace the first and second jaws relative to one another. The first and second jaws extend into the pincer-receiving channel, with the first jaw being coupled to the inner shaft and the second jaw being coupled to the pincer-receiving channel. When the jaw-displacing means operate to displace the first jaw relative to the second jaw, the inner and outer shaft members are thereby coaxially displaceable relative to one another for compressing the bulb member. The bulb member is actuable intermediate a relaxed bulb state (when the first and second jaw displacement is maximized) and an actuated bulb state (when the first and second jaw displacement is minimized). The relaxed bulb state enables shaft assembly insertion in a target conduit, and the actuated bulb state functions to selectively plug the target conduit.

Notably, the pincer assembly may be toggle-lockable insofar as the jaw-displacement means may preferably comprise a toggle-locking mechanism for toggle-locking the first and second jaws at the minimized first and second jaw displacement position. The toggle-lockable pincer assembly essentially functions to free a user's first and second hands for enabling single user, two-handed conduit maintenance.

Accordingly, although the invention has been described by reference to a number of preferred embodiments, it is not intended that the novel apparatus be limited thereby, but that modifications thereof are intended to be included as falling within the broad scope and spirit of the foregoing disclosure, the following claims and the appended drawings.

We claim:

1. A plumbing hand tool, the plumbing hand tool for selectively plugging conduit and comprising:
a conduit-penetrable shaft assembly, the shaft assembly comprising a hollow, rigid outer shaft member, a rigid inner shaft member, and a compressible, conduit-blockable bulb member, the outer shaft member having proximal and distal outer shaft ends, the inner shaft member having proximal and distal inner shaft ends, the bulb member having proximal and distal bulb ends, the outer and inner shafts being coaxial about a shaft axis;
a bulb-actuating pliers assembly, the pliers assembly comprising an inner shaft-engaging jaw, an outer shaft-engaging jaw, a jaw-receiving channel structure, and jaw-displacing means, the jaw-receiving channel having laterally opposed jaw-guiding flanges, the proximal inner shaft end extending into the jaw-receiving channel, the inner and outer shaft-engaging jaws extending into the jaw-receiving channel intermediate the jaw-guiding flanges, the inner shaft-engaging jaw being fixedly coupled to the proximal inner shaft end, the outer shaft-engaging jaw being pivotally coupled to the jaw-guiding flanges, the jaw-displacing means for simultaneously pivoting the outer shaft-engaging jaw about a pivot axis and displacing the inner shaft-engaging jaw along the shaft axis, the inner and outer shaft members thereby being coaxially displaceable relative to one another for compressing the bulb member via the distal inner and outer shaft ends, the bulb member being actuable intermediate an actuated bulb state and a relaxed bulb state, the bulb member having a first bulb diameter when in the relaxed bulb state and a second bulb diameter when in the actuated bulb state, the first diameter being less than a target conduit diameter, the first diameter thereby enabling shaft assembly insertion in a target conduit, the second diameter being substantially equal in magnitude to the target conduit diameter, the second diameter for selectively plugging the target conduit.

2. The plumbing hand tool of claim 1 wherein the jaw-displacing means comprise means for selectively preventing jaw-displacement.

3. The plumbing hand tool of claim 2 wherein the means for selectively preventing jaw-displacement are defined by a toggle mechanism.

4. The plumbing hand tool of claim 3 wherein the toggle mechanism comprises a hand-grippable structure, the hand-grippable structure effecting a substantially L-shaped plumbing hand tool, the L-shaped plumbing hand tool for enhancing a user's ability to selectively plug conduit.

5. The plumbing hand tool of claim 1 wherein the shaft assembly comprises bulb-interfacing means, the interfacing means for interfacing intermediate bulb member and the distal inner and outer shaft ends, the interfacing means for enhancing uniform compressibility of the bulb member via the distal inner and outer shaft ends.

6. The plumbing hand tool of claim 5 wherein the bulb-interfacing means are defined by first and second washers, each of the first and second washers comprising an inner washer diameter and an outer washer diameter, the inner washer diameter being greater in magnitude than the outer shaft diameter of the inner shaft member, the outer washer diameter being lesser in magnitude than the first bulb diameter, the distal inner and outer shaft ends being cooperatively associated with the first and second washers for uniformly compressing and selectively expanding the bulb member via the proximal and distal bulb ends.

7. A conduit-plugging hand tool, the conduit-plugging hand tool comprising:
a shaft assembly, the shaft assembly comprising inner and outer shaft members, and a bulb member, the outer shaft member having proximal and distal outer shaft ends, the proximal outer shaft end comprising a pincer-receiving channel, the inner shaft having proximal and distal inner shaft ends, the bulb member having proximal and distal bulb ends, the outer and inner shafts being coaxially displaceable along a shaft axis;
a pincer assembly, the pincer assembly comprising first and second jaws, and jaw-displacing means, the first and second jaws extending into the pincer-receiving channel, the first jaw being coupled to the proximal inner shaft end, the second jaw being coupled to the pincer-receiving channel, the jaw-displacing means for displacing the first jaw along the shaft axis relative to the second jaw, the inner and outer shaft members thereby being coaxially displaceable relative to one another for compressing the bulb member, the bulb member thereby being actuable intermediate a relaxed bulb state and an actuated bulb state, the relaxed bulb state enabling shaft assembly insertion in a target conduit, the actuated bulb state for selectively plugging the target conduit.

8. The conduit-plugging hand tool of claim 7 wherein the jaw-displacing means comprise means for selectively preventing jaw displacement, the means for selectively preventing jaw displacement enabling the user to selectively lock the bulb member in an actuated state.

9. The conduit-plugging hand tool of claim 8 wherein the means for selectively preventing jaw-displacement are defined by a toggle mechanism, the toggle mechanism for freeing a user's hands, the toggle mechanism thereby enabling single user, two-handed conduit maintenance.

10. The conduit-plugging hand tool of claim 7 wherein the jaw-displacing means define a hand-grippable structure, the hand-grippable structure for effecting a substantially L-shaped hand tool, the L-shaped hand tool for enhancing a user's ability to selectively plug conduit.

11. The conduit-plugging hand tool of claim 7 wherein the shaft assembly comprises bulb-interfacing means, the interfacing means for interfacing intermediate bulb member and the distal inner and outer shaft ends, the interfacing means for enhancing uniform compressibility of the bulb member via the distal inner and outer shaft ends.

12. The conduit-plugging hand tool of claim 11 wherein the bulb-interfacing means are defined by first and second washers, each of the first and second washers comprising an inner washer diameter and an outer washer diameter, the inner washer diameter being greater in magnitude than the outer shaft diameter of the inner shaft member, the outer washer diameter being lesser in magnitude than the first bulb diameter, the distal inner and outer shaft ends being cooperatively associated with the first and second washers for uniformly compressing and selectively expanding the bulb member via the proximal and distal bulb ends.

13. A conduit-plugging hand tool, the conduit-plugging hand tool comprising:
a shaft assembly, the shaft assembly comprising an inner shaft, an outer shaft, and a bulb member, the outer shaft member extending to a proximal pincer-receiving channel, the inner and outer shafts being coaxial about a shaft axis; and
a pincer assembly, the pincer assembly comprising first and second jaws, and jaw-displacing means, the first and second jaws extending into the pincer-receiving channel, the first jaw being coupled to the inner shaft, the second jaw being coupled to the pincer-receiving channel, the jaw-displacing means for displacing the first jaw relative to the second jaw, the inner and outer shaft members thereby being coaxially displaceable relative to one another for compressing the bulb member, the bulb member thereby being actuable intermediate a relaxed bulb state and an actuated bulb state, the relaxed bulb state enabling shaft assembly insertion in a target conduit, the actuated bulb state for selectively plugging the target conduit.

14. The conduit-plugging hand tool of claim 13 wherein the jaw-displacing means comprise a toggle-locking mechanism, the toggle-locking mechanism for freeing a user's hands and enabling single user, two-handed conduit maintenance.

15. The conduit-plugging hand tool of claim 14 wherein the jaw-displacing means define hand-grippable structure, the hand-grippable structure for effecting a substantially L-shaped hand tool, the L-shaped hand tool for enhancing a user's ability to selectively plug conduit.

16. A hand tool kit, the hand took kit for enabling a user to plug variously dimensioned conduit, the hand tool kit comprising:
an outer shaft, an inner shaft, a plurality of bulb members, and a pincer assembly, the bulb members respectively comprising a plurality of variously dimensioned transverse bulb diameters, the bulb diameters for plugging variously dimensioned conduit, the pincer assembly comprising first and second jaws, jaw-receiving channel structure, and jaw-displacing means, the first and second jaws being insertable into the channel structure and cooperable with the inner and outer shafts for coaxially displacing the inner shaft relative to the outer shaft for longitudinally compressing the select bulb member, the select bulb member thereby being actuable intermediate a relaxed bulb state and an actuated bulb state, the relaxed bulb state enabling shaft assembly insertion in a target conduit, the actuated bulb stated for selectively plugging the target conduit.

17. The hand tool kit of claim 16 wherein the outer shaft has proximal and distal outer shaft ends, the proximal outer shaft end being cooperable with the jaw-receiving channel structure, the inner shaft having proximal and distal inner shaft ends, each bulb member having proximal and distal bulb ends, the first jaw being removably coupled to the proximal inner shaft end, the second jaw being removably coupled to the jaw-receiving channel structure, the jaw-displacing means for displacing the first jaw relative to the second jaw, the inner and outer shaft members thereby being coaxially displaceable toward one another for compressing the select bulb member.

18. The hand tool kit of claim 16 wherein the pincer assembly comprises a hand-grippable structure, the hand-grippable structure and the inner and outer shafts for forming a substantially L-shaped hand tool, the L-shaped hand tool for enhancing a user's ability to selectively plug conduit.

19. The hand tool kit of claim 16 wherein the pincer assembly is toggle-lockable, the toggle-lockable pincer assembly for freeing a user's first and second hands, the pincer assembly thus enabling single user, two-handed conduit maintenance.

20. The hand tool kit of claim 17 comprising bulb-interfacing means, the bulb-interfacing means for interfacing intermediate the select bulb member and the distal inner and outer shaft ends, the bulb-interfacing means for enhancing uniform compressibility of the bulb member via the distal inner and outer shaft ends.
